(19) United States
(12) Patent Application Publication
(10) Pub. No.: US 2015/0215567 A1
(43) Pub. Date: Jul. 30, 2015

(54) SYSTEM AND METHOD FOR GENERATING A DISPLAY

(71) Applicant: MARK INTERNATIONAL, Oak Brook, IL (US)

(72) Inventors: Shafiq KHAN, Gaithersburg, MD (US); Asif AHMED, Lisle, IL (US)

(73) Assignee: MARK INTERNATIONAL, Oak Brook, IL (US)

(21) Appl. No.: 14/606,536

(22) Filed: Jan. 27, 2015

Related U.S. Application Data
(60) Provisional application No. 61/932,515, filed on Jan. 28, 2014.

(51) Int. Cl. H04N 5/64; H04N 7/025

(52) U.S. Cl. CPC H04N 5/64; H04N 7/0255

(57) ABSTRACT

System and method for generating a display to create an artificial window, the method including displaying, on a display screen, a first signal received from a first source via a first input of the display screen, and emitting lighting on a bezel of the display screen or a display member around the bezel or on a border within the display screen while the first signal is displayed on the display screen.

### CROSS-REFERENCE TO RELATED PATENT APPLICATION

This application claims priority from U.S. Provisional Application No. 61/932,515 filed on Jan. 28, 2014, the disclosure of which is incorporated herein by reference in its entirety.

### BACKGROUND

1. Technical Field

One or more exemplary embodiments relate to systems and methods for generating a display, and more particularly to systems and methods for generating a display to create an artificial window.

2. Description of the Related Art

In the related art, there are techniques disclosed for emitting lighting by way of various configurations, and in certain instances the disclosed techniques are directed to emitting the lighting for the purpose of treating Seasonal Affective Disorder (SAD).

For example, US 2012/0271384 to Muehlemann is directed to a light therapy device which “operates as an integral part of your computer monitor or screen, or your television screen (both places that average users spend a considerable amount of time—a necessary condition for light therapy) . . . While the current product is an aftermarket configuration, the patent concept extends to OEM manufacture and marketing of lighting products that are near or integrated into the computer or television monitor, panel or display screen specifically for the treatment of SAD” (Muehlemann, paragraph [0033], also see FIGS. 2-4).

### SUMMARY

The present inventors have recognized that the related art devices are configured to address specific light therapy needs and are not configured to address a general need for systems and methods for generating a display to create an artificial window in areas that lack a source of outside light.

For instance, areas in homes or offices or the like that lack a source of outside light such as windows are often undesirable. In a home setting, basements with sources of outside light are more attractive for living/renting etc. Similarly, in an office setting, meeting organizers and/or meeting participants may prefer conference rooms that have windows as opposed to those that do not. Workers assigned to cubicles in offices also express the desire to have a light source that can give them a view of the outside world.

One of the objectives of the present invention is to provide the ability to open up areas that lack light within homes and offices by providing systems and methods for generating a display to create an artificial window.

Accordingly, a non-limiting embodiment provides a system for generating a display, the system including a display screen including a bezel around a border of the display screen and a first input configured to receive a first signal from a first source, wherein the bezel is configured to emit lighting while the display screen is configured to display the first signal received from the first source via the first input.

The first input may be configured to receive a video signal as the first signal from the first source.

The first source may be a webcam.

The bezel may be configured to emit light of desired characteristics in the form of FSL or SWL.

The bezel may include a light source to emit the FSL or SWL.

The display screen and bezel may be configured to generate an artificial window by simultaneously displaying the video signal and emitting the FSL or SWL, respectively.

The system may include an input unit configured to receive an instruction identifying the video signal from among a plurality of available video signals.

Another non-limiting embodiment provides a system for generating a display, the system including a display screen including a bezel around a border of the display screen and a first input configured to receive a first signal from a first source; and a display member around a border of the bezel, wherein the display member is configured to emit lighting while the display screen is configured to display the first signal received from the first source via the first input.

Another non-limiting embodiment provides a system for generating a display, the system including a display screen and a first input configured to receive a first signal from a first source; and a controller configured to emit lighting on a border of the display screen while the display screen is configured to display the first signal at a portion of the display screen other than the border.

Another non-limiting embodiment provides a method of generating a display, the method including displaying, on a display screen including a bezel around a border of the display screen, a first signal received from a first source via a first input of the display screen; and emitting lighting on the bezel while displaying the first signal on the display screen.

Another non-limiting embodiment provides a method of generating a display, the method including displaying, on a display screen including a bezel around a border of the display screen, a first signal received from a first source via a first input of the display screen; and emitting lighting on a display member around a border of the bezel while displaying the first signal on the display screen.

Another non-limiting embodiment provides a method of generating a display, the method including emitting lighting on a border of a display screen; and displaying, on a portion of the display screen other than the border, a first signal received from a first source via a first input of the display screen while emitting the lighting on the border of the display screen.

### BRIEF DESCRIPTION OF DRAWINGS

FIG. 1 is a view of a system for generating a display according to a first non-limiting embodiment;

FIG. 2 is a view of a system for generating a display according to a second non-limiting embodiment;

FIG. 3 is a view of a system for generating a display according to a third non-limiting embodiment; and

FIG. 4 is a flowchart illustrating the implementation of the display method according to the third non-limiting embodiment.

### DETAILED DESCRIPTION OF EXEMPLARY EMBODIMENTS

All terms including descriptive or technical terms which are used herein should be construed as having their plain and ordinary meanings. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description. Thus, the terms used herein have to be defined based on the meaning of the terms together with the description throughout the specification.

Also, when a part “includes” or “comprises” an element, unless there is a particular description contrary thereto, the part may further include other elements, not excluding the other elements. In the following description, terms such as “unit” and “module” indicate a unit for processing at least one function or operation, wherein the unit and the block may be embodied as hardware or software or may be embodied by combining hardware and software.

One or more exemplary embodiments will now be described more fully with reference to the accompanying drawings. However, the one or more exemplary embodiments may be embodied in many different forms, and should not be construed as being limited to the exemplary embodiments set forth herein. Rather, these exemplary embodiments are provided so that this disclosure will be thorough and complete, and will fully convey the concept of the one or more exemplary embodiments to those of ordinary skill in the art. In the following description, well-known functions or constructions are not described in detail since they would obscure the one or more exemplar embodiments with unnecessary detail, and like reference numerals in the drawings denote like or similar elements throughout the specification.

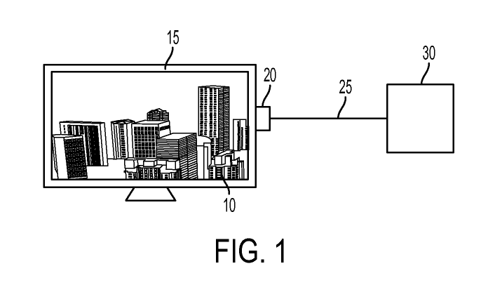

It will be readily understood that the components of the present invention, as generally described and illustrated in the figures herein, may be arranged and designed in a wide variety of different configurations. Thus, the following more detailed description of the embodiments as represented in FIGS. 1-4, is not intended to limit the scope of the invention, as claimed, but is merely representative of selected embodiments of the invention.

Referring now to FIGS. 1-4, systems and methods for generating a display to create an artificial window will be described.

### First Non-Limiting Embodiment

FIG. 1 is a view of a system for generating a display according to a first non-limiting embodiment.

Research studies in both Europe and the United States have shown that light therapy is effective in treating a form of depression often referred to as Seasonal Affective Disorder (SAD). The various forms of light therapy are found to improve a patient's condition by altering the production of melatonin and serotonin in the human brain (http://www.ncbi.nlm.nih.gov/pubmed/14962066 and http://www.ncbi.nlm.nih.gov/pmc/articles/PMC2913518/). Subsequent research has shown that two types of lighting are most effective in producing the desired results, the first being Full Spectrum Lighting (FSL) and the second being Short Wavelength Lighting (SWL). FSL mimics natural sunlight and produces a wide range of wavelengths of light and has been shown to be effective in treating SAD. Recent studies in treating SAD with light therapy have found that SWL between the ranges of 460 nm to 525 nm specifically contribute to the positive effect of light treatment for patients with SAD. Generating either FSL or SWL is achieved using a variety of know lighting methods such as incandescent, florescent, Plasma, LCD, LED and OLED technologies and possibly other light sources in the future. Both FSL and SWL can both be defined as light of a desired characteristic for treating SAD.

As shown in FIG. 1, the display system includes a display screen 10 including a bezel 15 around a border of the display screen 10 and a signal input 20 (e.g., HDMI input, DVI input, VGA input, Coax input, Component Inputs, Composite Input, S-Video Input, USB, wireless technologies, etc.) configured to receive a video signal 25 from one or more video sources 30 (e.g., webcam, cable box, streaming devices, media players, computer, remote server, etc.). The bezel 15 is configured to emit either full spectrum light (FSL) or short wavelength light (SWL) while the display screen 10 is configured to display the video signal 25 received from the one or more video sources 30 via the signal input 20.

As such, the existing bezel 15 around the display screen 10 is reconfigured to emit FSL (e.g., the bezel can be constructed to emit either FSL or SWL). The video source 30 is in communication with the display screen 10 via wireless or wired links to allow a person to view a bright outside scene in a room with limited natural lighting, acting as a window to the outside environment. The video sources(s) 30 can be positioned to allow optimal views (sunrise, southern exposure, scenic view, etc.) of surrounding scenes to allow the person to better view the outside environment from within. Alternatively, the video feed from the video sources(s) 30 can come from any remote location (e.g., from another country).

More specifically, the bezel 15 around the display screen 10 emits the FSL to emulate natural sunlight. User can watch television while absorbing FSL to increase the brightness in their area or for other reasons such as for treating the effects of Seasonal Affective Disorder (SAD). The bezel 15 is an integral part of the TV and can be constructed with either OLED, LED, LCD or Plasma light emitting cells as the light sources, which are the same technologies used in the display screen 10 of a display system (e.g., a television, a computer monitor, a personal digital assistant, smart devices including tablets or smartphones, etc.). Alternatively, other lighting technologies could also be used in the bezel 15 to produce the FSL with no compromise to the effectiveness of treating the user's preference or SAD condition.

The bezel 15 can be turned on or off independent of the display screen 10 being on or off (i.e., in the summer season, the bezel 15 may not need to be turned on if users get significant sunlight). The intensity of the full spectrum lighting can also be adjusted to ensure that the user receives the appropriate exposure to the lighting for the duration of television viewing session.

As an alternative to full spectrum lighting, the bezel 15 may be constructed to emit a SWL (wavelength of 460 nm-525 nm) which research has shown to effectively treat SAD. The proper frequency of SWL would need to be produced by the light emitting cells of the bezel panel.

As an integral but independent component of the display system, the bezel 15 may be turned on/off on a schedule that the user can program into the display system. Using a TV remote (or some other method, such as a smartphone, computer or other manner of programming the display system) the bezel 15 can be programmed to turn on during early mornings or late evenings to ensure users are exposed to the desired lighting during hours when sunlight is not available during the winter season.

Video source(s) 30 are used to provide exterior views, e.g., by using webcams. However, programming may be added to enable easy and customizable access to a wide variety of external video source/webcam networks such that the user may choose one or more video feeds from one or more video source/webcams by issuing an instruction to the display system via a menu interface.

### Second Non-Limiting Embodiment

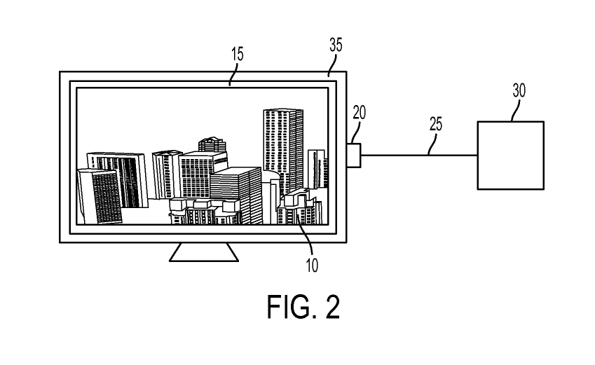

FIG. 2 is a view of a system for generating a display according to a second non-limiting embodiment.

The second non-limiting embodiment is similar to the first non-limiting embodiment except that the display system includes a panel frame 35 around a border of the bezel 15. Accordingly, elements of the system shown in FIG. 2 which are similar to the system shown in FIG. 1 are labeled with like reference numerals as those in FIG. 1.

In this second embodiment, instead of the bezel 15, the panel frame 35 is configured to emit FSL or SWL while the display screen 10 is configured to display the video signal 25 received from the one or more video sources 30 via the signal input 20. The panel frame 35 is an addition to an existing display system. The panel frame 35 can be added as an aftermarket item to a display system that may or may not already have a bezel 15 around the display screen 10.

The panel frame 35 can be controlled independently of the display screen 10, if desired. Software could enable activation and control of the display screen 10, the intensity/brightness of the lighting emitted by the panel frame 35, the video source(s) 30, through remote control devices, mouse/cursor, voice and/or motion activation, or the like.

### Third Non-Limiting Embodiment

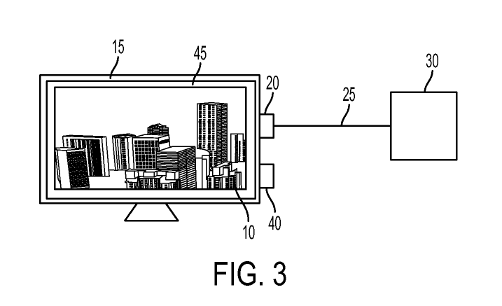

FIG. 3 is a view of a system for generating a display according to a third non-limiting embodiment.

The third non-limiting embodiment is similar to the first non-limiting embodiment except that instead of the bezel 15 emitting the FSL or SWL, the system includes a controller 40 that causes the display screen 10 to emit SWL along an outside border 45 of the display screen 10 while the display screen 10 is configured to display the video signal received from the video source 30 at a portion of the display screen 10 other than the border 45. Accordingly, elements of the system shown in FIG. 3 which are similar to the system shown in FIG. 1 are labeled with like reference numerals as those in FIG. 1.

In particular, the display system can be enhanced with a software program, executed on the controller 40, to create a border 45 on the display screen 10 which will emit SWL. Although the controller 40 is shown outside the display system in FIG. 1, the controller 40 could be included as part of the circuitry of the display system or in other electronic devices such as Cable Set-top boxes, DVRs, DVD Players, Game Consoles, Smartphones, Tablets, Computers, or another stand-alone devices. The signal displayed on the screen 10 (e.g., the video signal received from the video source 30 or another signal being displayed on the screen 10 received from another source such as a Set Top Box) can be adjusted to fit inside of the SWL border 45 and allow the user to receive the benefits of the enhanced SWL with an existing display system such as a television. The program that generates the border image 45 with the SWL and the resized program image that fits inside of the border image 45, can exist either directly in the display system or in other electronic devices such as Cable Set-top boxes, DVRs, DVD Players, Game Consoles, Smartphones, Tablets, Computers, or a device that can alter an image and contribute to the process of displaying an image on the screen 10.

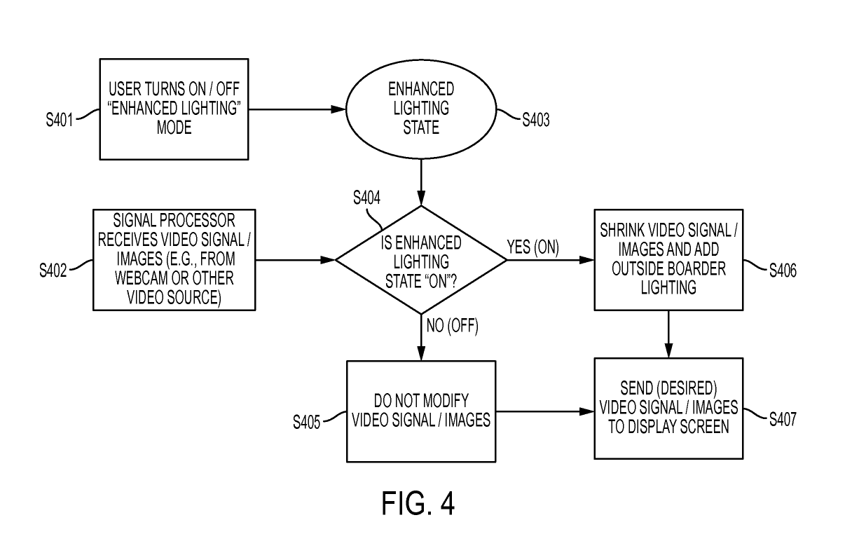

FIG. 4 is a flowchart illustrating the implementation of the display method according to the third non-limiting embodiment.

As shown in FIG. 4, the user is able to turn on/off the “Enhanced Lighting” mode (S401) that causes the controller 40 to decide if it needs to modify the video signal 25 received from a video source (S402) and add the border 45 to the modified (enhanced) video signal 25. If the “Enhanced Lighting” state (S403) is “On” (S404), the modification will be performed by the controller 40 (S406) and the modified signal will be sent to the display screen 10 (S407). If the “Enhanced Lighting” state is “Off”, no such modification to the video signal 25 will be performed (S405) and the original signal will be sent to the display screen 10 (S407).

One or more exemplary embodiments may also be embodied as programmed commands to be executed in various computer means, and then may be recorded to a computer-readable storage medium. The computer-readable storage medium may include one or more of the programmed commands, data files, data structures, or the like. The programmed commands recorded to the computer-readable storage medium may be particularly designed or configured for one or more exemplary embodiments. Examples of the computer-readable storage medium include magnetic media including hard disks, magnetic tapes, and floppy disks, optical media including CD-ROMs and DVDs, magneto-optical media including optical disks, and a hardware apparatus designed to store and execute the programmed commands in ROM, RAM, a flash memory, and the like. The hardware apparatus may be configured to function as one or more software modules so as to perform operations of one or more exemplary embodiments.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope of the inventive concept as defined by the following claims.

1. A system for generating a display, the system comprising:
a display screen including a bezel around a border of the display screen and a first input configured to receive a first signal from a first source;
wherein the bezel is configured to emit lighting while the display screen is configured to display the first signal received from the first source via the first input.

2. The system of claim 1, wherein the first input is configured to receive a video signal as the first signal from the first source.

3. The system of claim 2, wherein the first source is a webcam.

4. The system of claim 3, wherein the bezel is configured to emit light of desired characteristics in the form of FSL or SWL.

5. The system of claim 4, wherein the bezel comprises a light source to emit the FSL or SWL.

6. The system of claim 5, wherein the display screen and bezel are configured to generate an artificial window by simultaneously displaying the video signal and emitting the FSL or SWL, respectively.

7. The system of claim 6, further comprising:
an input unit configured to receive an instruction identifying the video signal from among a plurality of available video signals.

8. A system for generating a display, the system comprising:
a display screen including a bezel around a border of the display screen and a first input configured to receive a first signal from a first source; and
a display member around a border of the bezel, wherein the display member is configured to emit lighting while the display screen is configured to display the first signal received from the first source via the first input.

9. The system of claim 8, wherein the first input is configured to receive a video signal as the first signal from the first source, and the first source is a webcam.

10. The system of claim 9, wherein the display member is a panel frame disposed around the border of the bezel, and the panel frame is configured to emit light of desired characteristics in the form of FSL or SWL.

11. The system of claim 10, wherein the panel frame comprises a light source to emit the FSL or SWL.

12. The system of claim 11, wherein the display screen and the panel frame are configured to generate an artificial window by simultaneously displaying the video signal and emitting the FSL or SWL, respectively.

13. The system of claim 12, further comprising:
an input unit configured to receive an instruction identifying the video signal from among a plurality of available video signals.

14. A system for generating a display, the system comprising:
a display screen and a first input configured to receive a first signal from a first source; and
a controller configured to cause the display screen to emit lighting on a border of the display screen while the display screen is configured to display the first signal at a portion of the display screen other than the border.

15. The system of claim 14, wherein the first input is configured to receive a video signal as the first signal from the first source, and the first source is a webcam,
wherein the controller is configured to cause the display screen to emit SWL on the border of the display screen.

16. A method of generating a display, the method comprising:
displaying, on a display screen including a bezel around a border of the display screen, a first signal received from a first source via a first input of the display screen; and
emitting lighting on the bezel while displaying the first signal on the display screen.

17. A method of generating a display, the method comprising:
displaying, on a display screen including a bezel around a border of the display screen, a first signal received from a first source via a first input of the display screen; and
emitting lighting on a display member around a border of the bezel while displaying the first signal on the display screen.

18. A method of generating a display, the method comprising:
emitting lighting on a border of a display screen; and
displaying, on a portion of the display screen other than the border, a first signal received from a first source via a first input of the display screen while emitting the lighting on the border of the display screen.

19. The method of claim 18, further comprising:
receiving a video signal as the first signal from the first source, and the first source is a webcam,
wherein the emitting comprises emitting SWL on the border of the display screen.
